(19) United States
(12) Patent Application Publication
(10) Pub. No.: US 2025/0225023 A1
(43) Pub. Date: Jul. 10, 2025

(54) SERVER MAINTAINABILITY CONFIGURATION METHOD AND APPARATUS, ELECTRONIC DEVICE AND STORAGE MEDIUM

(71) Applicant: SUZHOU METABRAIN INTELLIGENT TECHNOLOGY CO.,, Suzhou (CN)

(72) Inventors: Shuaishuai JIA, Suzhou (CN); Daotong LI, Suzhou (CN); Shanbin AI, Suzhou (CN); Yandong CHEN, Suzhou (CN); Shengxin LI, Suzhou (CN)

(21) Appl. No.: 19/094,727

(22) Filed: Mar. 28, 2025

Related U.S. Application Data
(63) Continuation of application No. PCT/CN2024/100740, filed on Jun. 21, 2024.

(30) Foreign Application Priority Data
Aug. 14, 2023 (CN) 202311019304.8

(51) Int. Cl. G06F 11/07

(52) U.S. Cl. CPC G06F 11/0793; G06F 11/079

(57) ABSTRACT

A method and apparatus for configuring server maintainability, an electronic device and a non-transitory readable storage medium are provided by embodiments of the present application. The method includes: calculating a first utilization rate of a central processing unit, in response to a server starting and operating normally; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. In the embodiments of the present application, by determining whether a service of a client has been migrated, and based on whether the service has been migrated, different server configuration modes are activated, the crash rate of the server may be reduced.

### CROSS-REFERENCE TO RELATED APPLICATION

This application claims the priority of the Chinese Patent application filed on Aug. 14, 2023 before the China National Intellectual Property Administration with the application number of 202311019304.8, and the title of “SERVER MAINTAINABILITY CONFIGURATION METHOD AND APPARATUS, ELECTRONIC DEVICE AND STORAGE MEDIUM”, which is incorporated herein in its entirety by reference.

### FIELD

The present application relates to the technical field of computer systems and storage and, more particularly, to a method for configuring server maintainability, an apparatus for configuring server maintainability, an electronic device, and a non-transitory readable storage medium.

### BACKGROUND

Server faults may be divided into two types: crashing faults and non-crashing faults. The crashing faults are mainly caused in two parts: the crashing during starting and the crashing during operation. The server has a certain repair function for the fault component, even if the hardware fault of the server may occur, the necessary means may be used to make the server operate normally. This process is known as a reliability availability serviceability (RAS) function of the server. In certain scenarios, the RAS repair continues to operate with a default configuration of certain parameters until maintenance personnel perform fault resolution, which may affect server performance and operational efficiency and could further lead to server crashing.

### SUMMARY

In view of the above, a method for configuring server maintainability, an apparatus for configuring the server maintainability, an electronic device, and a non-transitory readable storage medium are provided by some embodiments of the present application to overcome, or at least partially solve the above-mentioned problems.

In order to solve the above-mentioned problems, in a first aspect of the present application, a method for configuring server maintainability is provided by some embodiments of the present application, which includes:
calculating a first utilization rate of a central processing unit, in response to a server starting and operating normally;
determining a fault component, in response to the server crashing and restarting;
calculating a second utilization rate of the central processing unit;
determining a service migration state based on the first utilization rate and the second utilization rate;
switching a server configuration mode according to the service migration state; and
isolating the fault component in the server configuration mode.

In some embodiments of the present application, the step of calculating the first utilization rate of the central processing unit includes:
reading power consumption data and unit heat data of the central processing unit; and
determining the first utilization rate according to the power consumption data and the unit heat data.

In some embodiments of the present application, the step of determining the first utilization rate according to the power consumption data and the unit heat data includes:
calculating a first ratio of the power consumption data to the unit heat data; and
determining the first ratio as the first utilization rate.

In some embodiments of the present application, the step of determining the fault component, in response to the server crashing and restarting includes:
reading error information, in response to the server crashing and restarting; and
determining that a component corresponding to the error information is the fault component.

In some embodiments of the present application, before the step of reading the error information, the step of determining the fault component, in response to the server crashing and restarting further includes:
waiting for a preset duration to enter a basic input/output system of the server.

In some embodiments of the present application, the step of calculating the second utilization rate of the central processing unit includes:
reading power consumption data and unit heat data of the central processing unit; and
determining the second utilization rate according to the power consumption data and the unit heat data.

In some embodiments of the present application, the step of determining the second utilization rate according to the power consumption data and the unit heat data includes:
calculating a second ratio of the power consumption data to the unit heat data; and
determining the second ratio as the second utilization rate.

In some embodiments of the present application, the step of determining the service migration state based on the first utilization rate and the second utilization rate includes:
calculating a service fluctuation value based on the first utilization rate and the second utilization rate; and
determining the service migration state based on the service fluctuation value.

In some embodiments of the present application, the step of calculating the service fluctuation value based on the first utilization rate and the second utilization rate includes:
calculating a difference between the first utilization rate and the second utilization rate;
calculating a third ratio of the difference to the first utilization rate; and
determining the third ratio to be the service fluctuation value.

In some embodiments of the present application, the step of determining the service migration state based on the service fluctuation value includes:
determining whether the service fluctuation value is less than a preset service fluctuation threshold;
determining that the service migration state is service non-migrated, in response to the service fluctuation value being less than the preset service fluctuation threshold; and
determining that the service migration state is service-migrated, in response to the service fluctuation value not being less than the preset service fluctuation threshold.

In some embodiments of the present application, the server configuration mode includes a reliability mode and an operability mode, operational reliability of the reliability mode is greater than operational reliability of the operability mode, and an operational efficiency of the operability mode is greater than an operational efficiency of the reliability mode; and the step of switching the server configuration mode according to the service migration state includes:
switching the server configuration mode to the reliability mode, in response to the service migration state being service non-migrated; and
switching the server configuration mode to the operability mode, in response to the service migration state being service-migrated.

In some embodiments of the present application, the step of switching the server configuration mode to the reliability mode, in response to the service migration state being service non-migrated includes:
setting a mode flag of the server as a reliability flag corresponding to the reliability mode, and controlling the server to restart, in response to the service migration state being service non-migrated; and
configuring a basic input/output system option of the server to switch to the reliability mode based on the reliability flag during restarting the server.

In some embodiments of the present application, the step of switching the server configuration mode to the operability mode, in response to the service migration state being service-migrated includes:
setting a mode flag of the server as an operational flag corresponding to the operability mode, and controlling the server to restart, in response to the service migration state being service-migrated; and
configuring a basic input/output system option of the server to switch to the operability mode based on the operational flag during restarting the server.

In some embodiments of the present application, the server configuration mode further includes a balanced mode and an auto mode, an operational efficiency of the balanced mode is between the operational efficiency of the reliability mode and the operational efficiency of the operability mode, and an operating reliability of the balanced mode is between the operating reliability of the reliability mode and the operating reliability of the operability mode; and the auto mode multiplexes one of the operability mode, the reliability mode and the balanced mode.

In some embodiments of the present application, the method further includes:
displaying a mode selection page, in response to the server starting and operating normally.

In some embodiments of the present application, the method further includes:
receiving a selection operation for the mode selection page, and selecting one of the reliability mode, the operability mode, the balanced mode and the auto mode as a current configuration mode.

In some embodiments of the present application, the preset service fluctuation threshold is 30%.

In a second aspect, an apparatus for configuring server maintainability is provided by an embodiment of the present application, which includes:
a first calculation module configured to calculate a first utilization rate of a central processing unit, in response to a server starting and operating normally;
a restarting module configured to determine a fault component, in response to the server crashing and restarting;
a second calculation module configured to calculate a second utilization rate of the central processing unit;
a service migration determining module configured to determine a service migration state based on the first utilization rate and the second utilization rate;
a switching module configured to switch a server configuration mode according to the service migration state; and
an isolation module configured to isolate the fault component in the server configuration mode.

In a third aspect, an electronic device is provided by an embodiment of the present application, which includes a processor, a memory, and a computer program stored on the memory and capable of operating on the processor, the computer program in response to being executed by the processor implementing the steps of the method for configuring the server maintainability stated above.

In a fourth aspect, a non-transitory readable storage medium is provided by an embodiment of the present application, wherein the non-transitory readable storage medium has stored thereon a computer program, the computer program, in response to being executed by a processor, implementing the steps of the method for configuring the server maintainability stated above.

The embodiments of the present application include the following advantages:
the embodiments of the present application are implemented by calculating a first utilization rate of a central processing unit, in response to a server starting and operating normally; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. It is determined whether the service of the client migrates by the utilization rate of the central processing unit during normal starting and restarting, and different server configuration modes are started according to whether the service migrates, so that the server may automatically switch the configuration model, and the crash rate of the server is reduced.

### BRIEF DESCRIPTION OF THE DRAWINGS

FIG. 1 is a flow diagram showing steps of a method for configuring server maintainability according to an embodiment of the present application;

FIG. 2 is a flow diagram showing steps of a method for configuring server maintainability according to another embodiment of the present application;

FIG. 3 is a schematic frame diagram showing an example of a method for configuring server maintainability according to the present application;

FIG. 4 is a structural block diagram of an apparatus for configuring server maintainability according to an embodiment of the present application;

FIG. 5 is a block diagram showing an electronic device according to an embodiment of the present application; and

FIG. 6 is a block diagram showing a storage medium according to an embodiment of the present application.

### DETAILED DESCRIPTION

In order to make the above-mentioned objectives, features, and advantages of the present application more clearly understandable, detailed description of the present application is further provided in conjunction with the accompanying drawings and embodiments below.

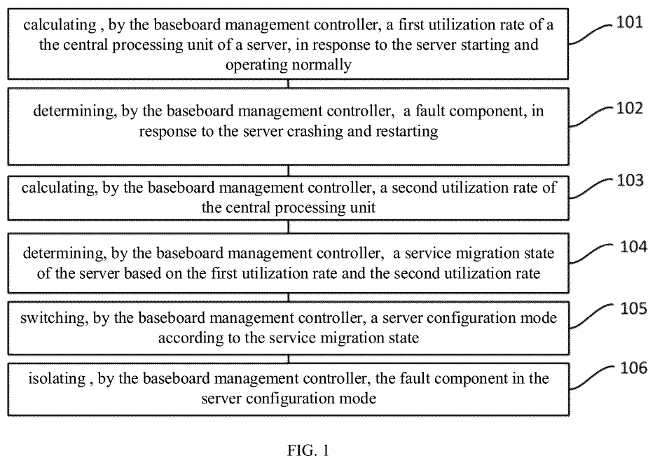

Referring to FIG. 1, FIG. 1 is a flow diagram showing steps of a method for configuring server maintainability according to an embodiment of the present application, wherein the server comprises a baseboard management controller (BMC) and a central processing unit (CPU) and the method for configuring the server maintainability may include the following steps:
Step 101, calculating, by the baseboard management controller, a first utilization rate of the central processing unit of a server, in response to the server starting and operating normally.

When the server starts and operates normally and performs service processing, the utilization rate of the central processing unit is calculated by the BMC at this moment, i.e., the first utilization rate.
Step 102, determining, by the baseboard management controller, a fault component, in response to the server crashing and restarting.

When the server is restarted due to a crashing of a fatal (fatal error) of a peripheral component interconnect express (PCIe) device or a unit cell error (UCE) of a memory or an internal error (IERR) of a central processing unit (CPU), a fault component of the server may be determined based on a way of reading a log.
Step 103, calculating, by the baseboard management controller, a second utilization rate of the central processing unit.

When there is crashing and restarting and the service is processed again, the utilization rate of the central processing unit at this time may be calculated, i.e., the second utilization rate.
Step 104, determining, by the baseboard management controller, a service migration state of the server based on the first utilization rate and the second utilization rate.

It is determined by the BMC whether the service running in the server is migrated to other servers by a user during restarting the server according to a relationship between the first utilization rate and the second utilization rate, and the service migration state is determined.
Step 105, switching, by the baseboard management controller, a server configuration mode according to the service migration state.

The server configuration mode that the server needs to switch is determined according to the service migration state, and the server is switched to the server configuration mode, so as to avoid crashing next time.
Step 106: isolating, by the baseboard management controller, the fault component in the server configuration mode.

The server operates in the switched server configuration mode to isolate the fault component until it is handled by a maintenance personnel, so that the server may continue to process the service during this time.

The embodiments of the present application is implemented by calculating a first utilization rate of a central processing unit, in response to a server starting and operating normally; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. It is determined whether the service of the client migrates by the utilization rate of the central processing unit during normal starting and restarting, and different server configuration modes are started according to whether the service migrates, so that the server may automatically switch the configuration model, and the crash rate of the server is reduced.

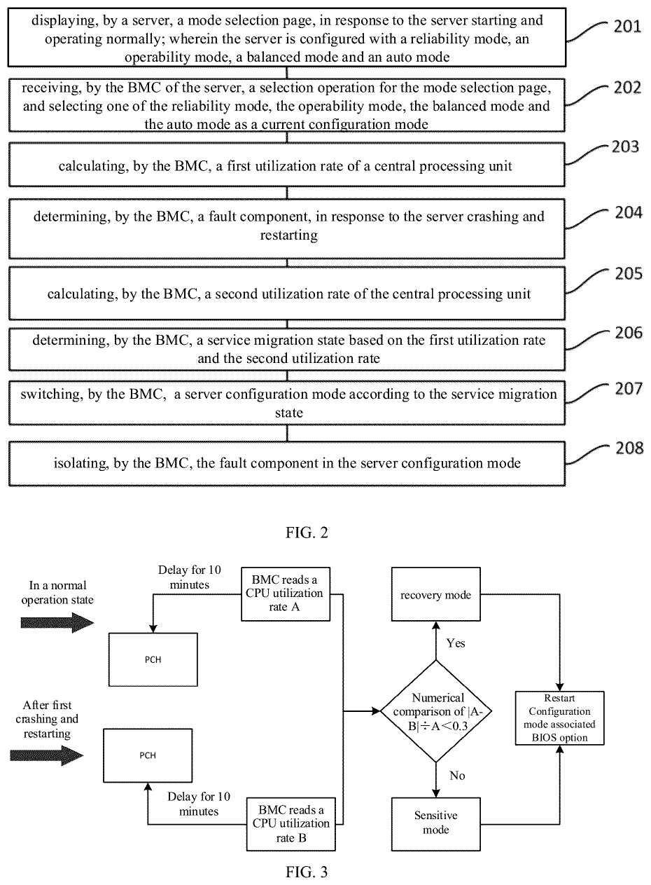

Referring to FIG. 2, FIG. 2 is a flow diagram showing steps of a method for configuring server maintainability according to another embodiment of the present application, wherein the server comprises a BMC and a CPU, and the method for configuring the server maintainability may include the following steps:
Step 201, displaying, by a server, a mode selection page, in response to the server starting and operating normally; wherein the server is configured with a reliability mode, an operability mode, a balanced mode and an auto mode.

In the embodiments of the present application, the server is configured with a reliability mode, an operability mode, a balanced mode and an auto mode. Operational reliability of the reliability mode is greater than operational reliability of the operability mode, and an operational efficiency of the operability mode is greater than an operational efficiency of the reliability mode; an operational efficiency of the balanced mode is between the operational efficiency of the reliability mode and the operational efficiency of the operability mode, and an operating reliability of the balanced mode is between the operating reliability of the reliability mode and the operating reliability of the operability mode; and the auto mode uses one of the operability mode, the reliability mode, and the balanced mode. The reliability mode may screen components with physical hardware faults without software repair, and allow the system to crash once a hardware fault is found. The operability mode may repair or predict the possible correctable error (CE) by various means so as to repair in advance, prolong the operating time of the server, and at the same time report the fault component to the baseboard management controller (BMC), and prompt the user to replace the fault component as soon as possible. In the balanced mode, the components with physical hardware fault may be screened, and the repair strategy that may be used is evaluated according to the fault components. If the repair strategy does not affect the system performance or has little effect on the system performance, the repair is selected. If the repair strategy used has great effect on the system performance, the crashing is selected. For the processing of the reliability mode, the operability mode and the balanced mode based on the RAS technology, they may be preconfigured by relevant personnel based on actual situations, which is not limited by the embodiments of the present application.

The reliability mode, the operability mode, and the balanced mode all contain multiple RAS technologies. In the RAS technologies, reliability refers to the fact that the system must be as reliable as possible without accidentally crashing, restarting or even causing physical damage to the system, which means that a reliable system must be able to self-repair for some small errors, and as far as possible to isolate the errors that cannot be self-repaired, so as to ensure the normal operation of the rest of system. Availability means that the system must be able to ensure that it works as long as possible without going off-line, and even if there are some minor problems with the system, it will not affect the normal operation of the whole system, and in some cases even Hot Plug operation may be performed to replace the problematic components, so as to strictly ensure that the crashing time of the system is within a certain range. Serviceability means that the system may provide convenient diagnostic functions, such as system log, dynamic detection and other means to facilitate the management personnel to perform system diagnosis and maintenance operations, so as to detect errors early and restore these errors. The role of RAS as a whole is to ensure that the whole system may operate reliably for as long as possible without going off-line, and has a sufficiently powerful fault-tolerant mechanism.

The RAS technologies included in the reliability mode include, but are not limited to shutting down double device data correction (DDDC) mechanism, shutting down memory Patrol Scrubbing (memory name), shutting down memory Post Package Repair (memory name), shutting down fault memory isolation startup technology, shutting down error containment default mode, shutting down fault core isolation startup, turning on Virus Mode, turning on error log hiding, shutting down enhanced downstream port containment (EDP), shutting down PCIe data containment mode, and shutting down PCIe Link retraining and recovery.

The RAS technologies included in the operability mode include but are not limited to: turning on adaptive double dram device correction (ADDDC) mechanism, turning on the DDDC mechanism, turning on the memory Patrol Scrubbing, turning on the memory Post Package Repair, turning on fault memory isolation start-up technology threshold setting: 3000, funnel setting: 1/min mask OS report/turning on memory ADDDC repair technology, shutting down the Viral Mode, shutting down the Error Log Cloaking, turning on enhanced downstream port containment (EDPC), turning on PCIe data containment mode, and turning on the PCIe link retraining and recovery.

The RAS technologies included in the balanced mode include, but not limited to shutting down ADDDC mechanism/turning on predictive cache leveling system (PCLS) mechanism, shutting down the DDDC mechanism, turning on the memory Patrol Scrubbing, turning on the memory Post Package Repair, turning on fault memory isolation boot technology, turning on the Viral Mode, shutting down the Error Log Cloaking, shutting down the enhanced downstream port containment (EDPC), turning on the PCIe data containment mode, and turning on the PCIe link retraining and recovery.

When the server starts and operates normally, a display mode selection page may be started, and the user may select a configuration mode configured for the server in the mode selection page.
Step 202, receiving, by the BMC of the server, a selection operation for the mode selection page, and selecting one of the reliability mode, the operability mode, the balanced mode and the auto mode as a current configuration mode.

The configuration mode selected by the user is determined according to the user's selection operation for the mode selection page, and one of the configuration modes is determined to be the current configuration mode from among the reliability mode, the operability mode, the balanced mode and the auto mode, so as to configure the server.
Step 203, calculating, by the BMC, a first utilization rate of a central processing unit.

The utilization rate of the central processing unit at this time, i.e., the first utilization rate, may be calculated after the server has been operating for a certain time, e.g., 10 minutes.

In some embodiments of the present application, the step of calculating a first utilization rate of the central processing unit includes: reading power consumption data and unit heat data of the central processing unit; and determining the first utilization rate according to the power consumption data and the unit heat data.

The BMC in the server may read the power consumption data of the central processing unit and the unit heat data (that is thermal design power (TDP)) of the central processing unit. The power consumption data and the unit heat data of a south bridge integrated circuit of the central processing unit may be taken as the criteria. The first utilization rate is then determined based on a magnitude relationship between the power consumption data and the unit heat data. The unit heat data is the TDP thermal power consumption, which is an indicator of heat release of the processor.

According to the power consumption data and the unit heat data, the step of determining the first utilization rate includes: calculating a first ratio of the power consumption data to the unit heat data; and determining the first ratio as the first utilization rate.

In the practical application, a ratio of the power consumption data to the unit heat data may be calculated, i.e., the ratio of the power consumption data/the unit heat data is the first ratio; the first ratio may be taken as the first utilization rate.
Step 204, determining, by the BMC, a fault component, in response to the server crashing and restarting.

During the operation of the server, the server may be subjected to crashing and restarting due to various errors. When the server crashes and is restarted, the fault component may be determined from the server.

In some embodiments of the present application, the step of determining the fault component, in response to the server crashing and restarting includes: reading error information, in response to the server crashing and restarting; and determining that a component corresponding to the error information is the fault component.

The error information may be read from operating data such as a log, in response to the server crashing and restarting; the corresponding fault component is determined based on the error information, and the component is determined as the fault component.

In some embodiments of the present application, before the step of reading the error information, the step of determining the fault component, in response to the server crashing and restarting further includes: waiting for a preset duration to enter a basic input/output system of the server.

When the error information is a UCE fault or an IERR fault, the step of determining that the component corresponding to the error information is the fault component may be performed by waiting for a preset duration and delaying to enter the basic input/output system of the server. The preset duration may be determined based on a person skilled in the art, which is not limited by the embodiments of the present application. As in one example of the present application, the preset duration is 10 minutes.
Step 205, calculating, by the BMC, a second utilization rate of the central processing unit.

After the crashing and restarting of the server, the second utilization rate of the central processing unit may also be calculated to determine the service processing after the restarting.

In some embodiments of the present application, the step of calculating the second utilization rate of the central processing unit includes: reading power consumption data and unit heat data of the central processing unit; and determining the second utilization rate according to the power consumption data and the unit heat data.

Similarly to the first utilization rate, the BMC may read the power consumption data of the central processing unit and the unit heat data of the central processing unit after the crashing and restarting, and then determine the second utilization rate according to a magnitude relationship between the power consumption data and the unit heat data.

According to the power consumption data and the unit heat data, the step of determining the first utilization rate includes: calculating a second ratio of the power consumption data to the unit heat data; and determining the second ratio as the first utilization rate.

In the practical application, a ratio of the power consumption data to the unit heat data may be calculated, i.e., the ratio of the power consumption data to the unit heat data is the second ratio; the second ratio may be taken as the second utilization rate.
Step 206, determining, by the BMC, a service migration state based on the first utilization rate and the second utilization rate.

Based on the relationship between the first utilization rate and the second utilization rate, it may be determined whether a service migration has occurred for the server, and the service may be migrated to other servers.

In some embodiments of the present application, the step of determining the service migration state based on the first utilization rate and the second utilization rate includes: calculating a service fluctuation value based on the first utilization rate and the second utilization rate; and determining a service migration state based on the service fluctuation value.

In the embodiments of the present application, the first utilization rate and the second utilization rate may be calculated, and based on the first utilization rate and the second utilization rate, the fluctuation of service before and after the crashing and restarting is determined, and a service fluctuation value is calculated. The service migration state is determined based on the service fluctuation value.

The step of calculating the service fluctuation value based on the first utilization rate and the second utilization rate includes: calculating a difference between the first utilization rate and the second utilization rate; calculating a third ratio of the difference to the first utilization rate; and determining the third ratio to be the service fluctuation value.

In the embodiments of the present application, a difference between the first utilization rate and the second utilization rate may be calculated, wherein for unified description, both migration-in and migration-out are treated as service migration in a unified manner, and the difference between the first utilization rate and the second utilization rate may be calculated using absolute values for subsequent calculation. That is, the absolute value of the difference of the first utilization rate minus the second utilization rate may be used, or the absolute value of the difference of the second utilization rate minus the first utilization rate may be used to enter subsequent calculation. The ratio of the difference to the first utilization rate, i.e., the third ratio, is then calculated by means of that the amount of change of the service migrated-in and migrated-out with respect to the amount before the crashing and restarting may be determined. The third ratio is the service fluctuation value.

The step of determining the service migration state based on the service fluctuation value includes: determining whether the service fluctuation value is less than a preset service fluctuation threshold; determining that the service migration state is service non-migrated, in response to the service fluctuation value being less than the preset service fluctuation threshold; and determining that the service migration state is service-migrated, in response to the service fluctuation value not being less than the preset service fluctuation threshold.

In the practical application, it may be determined whether the service fluctuation value is less than a preset service fluctuation threshold to determine a service migration state, wherein the preset service fluctuation threshold may be determined according to actual situations, which is not limited by the embodiments of the present application. In some examples of the present application, the preset service fluctuation threshold may be 30%.

When the service fluctuation value is less than the preset service fluctuation threshold, in response to the service fluctuation value being less than the preset service fluctuation threshold, i.e., before and after restarting, the service processing amount in the server is stable; it may be determined that the service migration state is service non-migrated.

When the service fluctuation value is not less than the preset service fluctuation threshold, in response to the service fluctuation value being not less than the preset service fluctuation threshold, i.e., the change in the service processing amount in the server before and after the restarting is large; it may be determined that the service migration state is service non-migrated.
Step 207, switching, by the BMC, a server configuration mode according to the service migration state.

According to different service migration states, the current configuration mode of the server may be switched to the server configuration mode corresponding to the service migration state.

In some embodiments of the present application, the step of switching the server configuration mode according to the service migration state includes: switching the server configuration mode to the reliability mode, in response to the service migration state being service non-migrated; and switching the server configuration mode to the operability mode, in response to the service migration state being service-migrated.

In the embodiments of the present application, when the service migration state is the service non-migrated, in response to the service migration state being the service non-migrated, the server configuration mode is switched to the reliability mode, and the server is configured to operate based on the reliability mode. When the service migration state is service-migrated, in response to the service migration state being service-migrated, the server configuration mode is switched to the operability mode, and the server is configured to operate based on the operability mode.

The step of switching the server configuration mode to the reliability mode, in response to the service migration state being service non-migrated includes: setting a mode flag of the server as a reliability flag corresponding to the reliability mode, and controlling the server to restart, in response to the service migration state being service non-migrated; and configuring a basic input/output system option of the server to switch to the reliability mode based on the reliability flag during restarting the server.

In the practical application, a mode flag of the server may be set to a reliability flag corresponding to the reliability mode, in response to the service migration state being service non-migrated, and the reliability flag may be stored, and then the control server may be restarted to perform parameter reconfiguration. During restarting the server, according to the reliability flag, all the parts of the basic input/output system options of the server associated with the reliability mode are reconfigured and switched to the parameters corresponding to the reliability mode.

The step of switching the server configuration mode to the operability mode, in response to the service migration state being service-migrated includes: setting a mode flag of the server as an operational flag corresponding to the operability mode, and controlling the server to restart, in response to the service migration state being service-migrated; and configuring the basic input/output system option of the server to switch to the operability mode based on the operational flag during restarting the server.

In the practical application, the mode flag of the server may be set to an operational flag corresponding to the operability mode, in response to the service migration state being service-migrated, and the operational flag may be stored, and then the control server may be restarted for performing parameter reconfiguration. During restarting the server, according to the operational flag, all the parts of the basic input/output system options of the server associated with the operability mode are reconfigured and switched to the parameters corresponding to the operability mode.

The operational flag and the reliability flag may be provided in the form of a flag according to actual situations, which is not limited by the embodiments of the present application.
Step 208, isolating, by the BMC, the fault component in the server configuration mode.

After switching to a new server configuration mode, operation is performed in the server configuration mode, and the fault component is isolated to determine normal operation of the server.

The embodiments of the present application are implemented by displaying a mode selection page, in response to the server starting and operating normally; wherein the server is configured with a reliability mode, an operability mode, a balanced mode and an auto mode; receiving a selection operation for the mode selection page, and selecting one of the reliability mode, the operability mode, the balanced mode and the auto mode as a current configuration mode; calculating a first utilization rate of a central processing unit; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. It is determined whether the service of the client migrates by the utilization rate of the central processing unit during normal starting and restarting, and different server configuration modes are started according to whether the service migrates, so that the server may automatically switch the configuration model, and the crash rate of the server is reduced.

In order to enable a person skilled in the art to better understand the embodiments of the present application, and the embodiments of the present application are described below by way of example:
1) First, an RAS Mode option is added under BIOS setup of a basic input/output system (BIOS) interactive interface of the server, such as an operability mode (sensitive mode), a recovery mode, a balanced mode and an auto mode.
2) One of the modes is selected according to a user selection operation. For example, the auto mode is selected.

Referring to FIG. 3, FIG. 3 is a schematic diagram of an example of a method for configuring server maintainability according to the present application; and the method for configuring the server maintainability may include the following steps:
1. During the phase of normal server operation for client services, the BMC reads the CPU utilization rate through the PCIe, and the utilization rate is recorded as A.
2. If the fault machine of the client firstly crashes, the server will automatically restart after the crash (the restart mechanism may be triggered by a fatal error in the PCIe device, an UCE in memory, or an IERR in the CPU, etc.).
3. The BMC detects that the restart reason is due to a UCE fault or an IERR fault. Then, 10 minutes after entering the system, a CPU utilization rate B is read again.
4. The formula for calculating whether or not to decide which mode to switch is: numerical comparison shows whether |A−B|÷A<0.3 is true or false. A 30 percent fluctuation in client service operation is considered normal, and if the service is migrated out, the CPU utilization rate is very low, well below the 30 percent fluctuation in CPU utilization rate.
5. The numerical comparison shows |A−B|÷A<0.3 to be true, indicating that client service has not migrated from the fault machine, and an RAS mode flag is set to be a recovery mode flag. The server is then actively restarted by the BMC.
6. The numerical comparison shows |A−B|÷A<0.3 to be false, indicating that client service has migrated from the fault machine, and an RAS mode flag is set to an operability mode (sensitive mode) flag. The server is then actively restarted by the BMC.
7. During a restarting phase of the server, the BIOS reads the RAS mode flag saved by the BMC, and then configures the corresponding BIOS parameters according to different RAS modes.

It should be noted that for simplicity of explanation, method embodiments have been presented as a series of combinations of acts, but a person skilled in the art will recognize that the embodiments of the present application are not limited by the illustrated order of acts, as some acts may, according to the embodiments of the present application, occur in other orders or concurrently. Further, a person skilled in the art will also appreciate that the embodiments described in the specification are presently considered to be embodiments, and that the acts involved are not necessarily required by the embodiments of the present application.

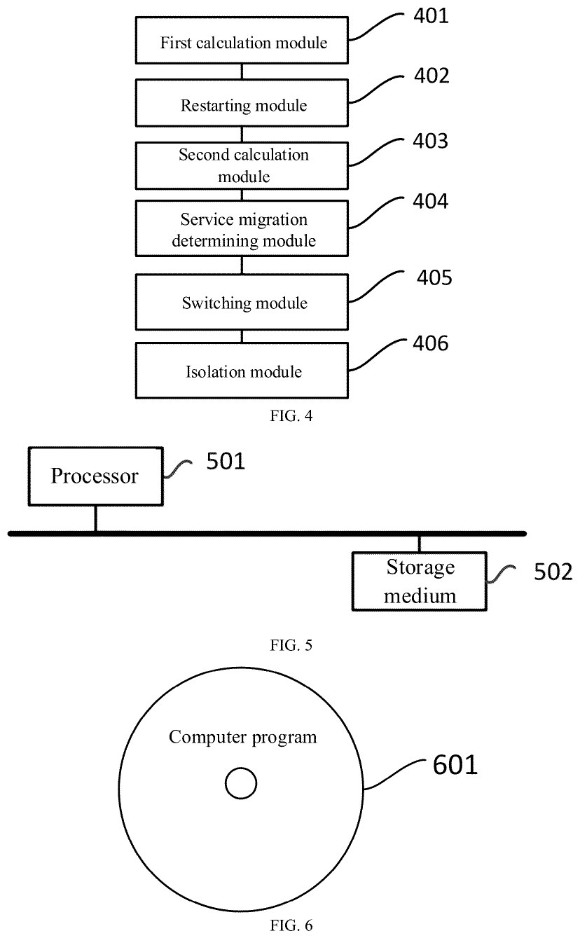

Referring to FIG. 4, FIG. 4 is a structural block diagram of an apparatus for configuring server maintainability according to an embodiment of the present application, and the apparatus for configuring the server maintainability may include the following modules:
a first calculation module 401 configured to calculate a first utilization rate of a central processing unit, in response to a server starting and operating normally;
a restarting module 402 configured to determine a fault component, in response to the server crashing and restarting;
a second calculation module 403 configured to calculate a second utilization rate of the central processing unit;
a service migration determining module 404 configured to determine a service migration state based on the first utilization rate and the second utilization rate;
a switching module 405 configured to switch a server configuration mode according to the service migration state; and
an isolation module 406 configured to isolate the fault component in the server configuration mode.

In some embodiments of the present application, the first calculation module 401 includes:
a first reading sub-module configured to read power consumption data and unit heat data of the central processing unit; and
a first utilization rate determination sub-module configured to determine the first utilization rate according to the power consumption data and unit heat data.

In some embodiments of the present application, the first utilization rate determination sub-module includes:
a first calculation unit configured to calculate a first ratio of the power consumption data to the unit heat data; and
a first utilization rate determination unit configured to determine the first ratio as the first utilization rate.

In some embodiments of the present application, the restarting module 402 includes:
a restart sub-module configured to read error information, in response to the server crashing and restarting; and
a fault determination sub-module configured to determine that a component corresponding to the error information is the fault component.

In some embodiments of the present application, the restarting module 402 further includes:
a waiting sub-module configured to wait for a preset duration to enter a basic input/output system of the server.

In some embodiments of the present application, the second calculation module 403 includes:
a second reading sub-module configured to read power consumption data and unit heat data of the central processing unit; and
a second utilization rate determination sub-module configured to determine the second utilization rate according to the power consumption data and unit heat data.

In some embodiments of the present application, the second utilization rate determination sub-module includes:
a second calculation unit configured to calculate a second ratio of the power consumption data to the unit heat data; and
a second utilization rate determination unit configured to determine the second ratio as the second utilization rate.

In some embodiments of the present application, the service migration determining module 404 includes:
a service fluctuation value determination sub-module configured to calculate a service fluctuation value based on the first utilization rate and the second utilization rate; and
a service migration state determination sub-module configured to determine a service migration state based on the service fluctuation value.

In some embodiments of the present application, the service fluctuation value determination sub-module includes:
a difference calculation unit configured to calculate a difference between the first utilization rate and the second utilization rate;
a third ratio calculation unit configured to calculate a third ratio of the difference to the first utilization rate; and
a service fluctuation value determination unit configured to determine the third ratio to be the service fluctuation value.

In some embodiments of the present application, the service migration state determination sub-module includes:
a determining unit configured to determine whether the service fluctuation value is less than a preset service fluctuation threshold;
a first migration determination unit configured to determine that the service migration state is service non-migrated, in response to the service fluctuation value being less than the preset service fluctuation threshold; and
a second migration determination unit configured to determine that the service migration state is service-migrated, in response to the service fluctuation value not being less than the preset service fluctuation threshold.

In some embodiments of the present application, the server configuration mode includes a reliability mode and an operability mode, operational reliability of the reliability mode is greater than operational reliability of the operability mode, and an operational efficiency of the operability mode is greater than an operational efficiency of the reliability mode; and the switching module 405 includes:
a first switching sub-module configured to switch the server configuration mode to the reliability mode, in response to the service migration state being service non-migrated; and
a second switching sub-module configured to switch the server configuration mode to the operability mode, in response to the service migration state being service-migrated.

In some embodiments of the present application, the first switching sub-module includes:
a first flag unit configured to set a mode flag of the server as a reliability flag corresponding to the reliability mode, and control the server to restart, in response to the service migration state being service non-migrated; and
a first configuration unit configured to configure a basic input/output system option of the server to switch to the reliability mode based on the reliability flag during restarting the server.

In some embodiments of the present application, the second switching sub-module includes:
a second flag unit configured to set a mode flag of the server as an operational flag corresponding to the operability mode, and control the server to restart, in response to the service migration state being service-migrated; and
a second configuration unit configured to configure the basic input/output system option of the server to switch to the operability mode based on the operational flag during restarting the server.

In some embodiments of the present application, the server configuration mode further includes a balanced mode and an auto mode, an operational efficiency of the balanced mode is between the operational efficiency of the reliability mode and the operational efficiency of the operability mode, and an operating reliability of the balanced mode is between the operating reliability of the reliability mode and the operating reliability of the operability mode; and the auto mode multiplexes one of the operability mode, the reliability mode and the balanced mode.

In some embodiments of the present application, the apparatus further includes:
a display module configured to display a mode selection page, in response to the server starting and operating normally.

In some embodiments of the present application, the apparatus further includes:
a selection module configured to receive a selection operation for the mode selection page, and select one of the reliability mode, the operability mode, the balanced mode and the auto mode as a current configuration mode.

In some embodiments of the present application, the preset service fluctuation threshold is 30%.

The embodiments of the present application is implemented by calculating a first utilization rate of a central processing unit, in response to a server starting and operating normally; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. It is determined whether the service of the client migrates by the utilization rate of the central processing unit during normal starting and restarting, and different server configuration modes are started according to whether the service migrates, so that the server may automatically switch the configuration model, and the crash rate of the server is reduced.

The description is relatively simple with respect to the embodiments of the apparatus, since it is substantially similar to the embodiments of the method, to which reference is made for a partial explanation.

Referring to FIG. 5, an electronic device is further provided by the embodiments of the present application, which includes:
a processor 501 and a storage medium 502, wherein the storage medium 502 stores a computer program executable by the processor 501, and when the electronic device is operating, the processor 501 executes the computer program so as to execute the method for configuring the server maintainability according to any one of the embodiments of the present application. The method for configuring the server maintainability includes:
calculating a first utilization rate of a central processing unit, in response to a server starting and operating normally;
determining a fault component, in response to the server crashing and restarting;
calculating a second utilization rate of the central processing unit;
determining a service migration state based on the first utilization rate and the second utilization rate;
switching a server configuration mode according to the service migration state; and
isolating the fault component in the server configuration mode.

In some embodiments of the present application, the step of calculating the first utilization rate of the central processing unit includes:
reading power consumption data and unit heat data of the central processing unit; and
determining the first utilization rate according to the power consumption data and the unit heat data.

In some embodiments of the present application, the step of determining the first utilization rate according to the power consumption data and the unit heat data includes:
calculating a first ratio of the power consumption data to the unit heat data; and
determining the first ratio as the first utilization rate.

In some embodiments of the present application, the step of determining the fault component, in response to the server crashing and restarting includes:
reading error information, in response to the server crashing and restarting; and
determining that a component corresponding to the error information is the fault component.

In some embodiments of the present application, before the step of reading the error information, the step of determining the fault component, in response to the server crashing and restarting further includes:
waiting for a preset duration to enter a basic input/output system of the server.

In some embodiments of the present application, the step of calculating the second utilization rate of the central processing unit includes:
reading power consumption data and unit heat data of the central processing unit; and
determining the second utilization rate according to the power consumption data and the unit heat data.

In some embodiments of the present application, the step of determining the first utilization rate according to the power consumption data and the unit heat data includes:
calculating a second ratio of the power consumption data to the unit heat data; and
determining the second ratio as the second utilization rate.

In some embodiments of the present application, the step of determining the service migration state based on the first utilization rate and the second utilization rate includes:
calculating a service fluctuation value based on the first utilization rate and the second utilization rate; and
determining a service migration state based on the service fluctuation value.

In some embodiments of the present application, the step of calculating the service fluctuation value based on the first utilization rate and the second utilization rate includes:
calculating a difference between the first utilization rate and the second utilization rate;
calculating a third ratio of the difference to the first utilization rate; and
determining the third ratio to be the service fluctuation value.

In some embodiments of the present application, the step of determining the service migration state based on the service fluctuation value includes:
determining whether the service fluctuation value is less than a preset service fluctuation threshold;
determining that the service migration state is service non-migrated, in response to the service fluctuation value being less than the preset service fluctuation threshold; and
determining that the service migration state is service-migrated, in response to the service fluctuation value not being less than the preset service fluctuation threshold.

In some embodiments of the present application, the server configuration mode includes a reliability mode and an operability mode, operational reliability of the reliability mode is greater than operational reliability of the operability mode, and an operational efficiency of the operability mode is greater than an operational efficiency of the reliability mode; and the step of switching the server configuration mode according to the service migration state includes:
switching the server configuration mode to the reliability mode, in response to the service migration state being service non-migrated; and
switching the server configuration mode to the operability mode, in response to the service migration state being service-migrated.

In some embodiments of the present application, the step of switching the server configuration mode to the reliability mode, in response to the service migration state being service non-migrated includes:
setting a mode flag of the server as a reliability flag corresponding to the reliability mode, and controlling the server to restart, in response to the service migration state being service non-migrated; and
configuring a basic input/output system option of the server to switch to the reliability mode based on the reliability flag during restarting the server.

In some embodiments of the present application, the step of switching the server configuration mode to the operability mode, in response to the service migration state being service-migrated includes:
setting a mode flag of the server as an operational flag corresponding to the operability mode, and controlling the server to restart, in response to the service migration state being service-migrated; and
configuring the basic input/output system option of the server to switch to the operability mode based on the operational flag during restarting the server.

In some embodiments of the present application, the server configuration mode further includes a balanced mode and an auto mode, an operational efficiency of the balanced mode is between the operational efficiency of the reliability mode and the operational efficiency of the operability mode, and an operating reliability of the balanced mode is between the operating reliability of the reliability mode and the operating reliability of the operability mode; and the auto mode multiplexes one of the operability mode, the reliability mode and the balanced mode.

In some embodiments of the present application, the method further includes:
displaying a mode selection page, in response to the server starting and operating normally.

In some embodiments of the present application, the method further includes:
receiving a selection operation for the mode selection page, and selecting one of the reliability mode, the operability mode, the balanced mode and the auto mode as a current configuration mode.

In some embodiments of the present application, the preset service fluctuation threshold is 30%.

The memory may include random access memory (RAM) or may include non-transitory memory, e.g., at least one disk memory. Alternatively, the memory may also be at least one memory apparatus located remotely from the aforementioned processor.

The above-mentioned processor may be a general-purpose processor, including a central processing unit (CPU), a Network processor (NP), etc.; it may also be a digital signal processor (DSP), an application specific integrated circuit (ASIC), a field-programmable gate array (FPGA) or other programmable logic devices, discrete gate or transistor logic devices, and discrete hardware components.

The embodiments of the present application is implemented by calculating a first utilization rate of a central processing unit, in response to a server starting and operating normally; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. It is determined whether the service of the client migrates by the utilization rate of the central processing unit during normal starting and restarting, and different server configuration modes are started according to whether the service migrates, so that the server may automatically switch the configuration model, and the crash rate of the server is reduced.

Referring to FIG. 6, a non-transitory readable storage medium 601 is further provided by an embodiment of the present application, on which a computer program is stored, the computer program being executed by a processor to perform the method for configuring the server maintainability according to any one of the embodiments of the present application. The method for configuring the server maintainability includes:
calculating a first utilization rate of a central processing unit, in response to a server starting and operating normally;
determining a fault component, in response to the server crashing and restarting;
calculating a second utilization rate of the central processing unit;
determining a service migration state based on the first utilization rate and the second utilization rate;
switching a server configuration mode according to the service migration state; and
isolating the fault component in the server configuration mode.

In some embodiments of the present application, the step of calculating the first utilization rate of the central processing unit includes:
reading power consumption data and unit heat data of the central processing unit; and
determining the first utilization rate according to the power consumption data and the unit heat data.

In some embodiments of the present application, the step of determining the first utilization rate according to the power consumption data and the unit heat data includes:
calculating a first ratio of the power consumption data to the unit heat data; and
determining the first ratio as the first utilization rate.

In some embodiments of the present application, the step of determining the fault component, in response to the server crashing and restarting includes:
reading error information, in response to the server crashing and restarting; and
determining that a component corresponding to the error information is the fault component.

In some embodiments of the present application, before the step of reading the error information, the step of determining the fault component, in response to the server crashing and restarting further includes:
waiting for a preset duration to enter a basic input/output system of the server.

In some embodiments of the present application, the step of calculating the second utilization rate of the central processing unit includes:
reading power consumption data and unit heat data of the central processing unit; and
determining the second utilization rate according to the power consumption data and the unit heat data.

In some embodiments of the present application, the step of determining the first utilization rate according to the power consumption data and the unit heat data includes:
calculating a second ratio of the power consumption data to the unit heat data; and
determining the second ratio as the second utilization rate.

In some embodiments of the present application, the step of determining the service migration state based on the first utilization rate and the second utilization rate includes:
calculating a service fluctuation value based on the first utilization rate and the second utilization rate; and
determining a service migration state based on the service fluctuation value.

In some embodiments of the present application, the step of calculating the service fluctuation value based on the first utilization rate and the second utilization rate includes:
calculating a difference between the first utilization rate and the second utilization rate;
calculating a third ratio of the difference to the first utilization rate; and
determining the third ratio to be the service fluctuation value.

In some embodiments of the present application, the step of determining the service migration state based on the service fluctuation value includes:
determining whether the service fluctuation value is less than a preset service fluctuation threshold;
determining that the service migration state is service non-migrated, in response to the service fluctuation value being less than the preset service fluctuation threshold; and
determining that the service migration state is service-migrated, in response to the service fluctuation value not being less than the preset service fluctuation threshold.

In some embodiments of the present application, the server configuration mode includes a reliability mode and an operability mode, operational reliability of the reliability mode is greater than operational reliability of the operability mode, and an operational efficiency of the operability mode is greater than an operational efficiency of the reliability mode; and the step of switching the server configuration mode according to the service migration state includes:
switching the server configuration mode to the reliability mode, in response to the service migration state being service non-migrated; and
switching the server configuration mode to the operability mode, in response to the service migration state being service-migrated.

In some embodiments of the present application, the step of switching the server configuration mode to the reliability mode, in response to the service migration state being service non-migrated includes:
setting a mode flag of the server as a reliability flag corresponding to the reliability mode, and controlling the server to restart, in response to the service migration state being service non-migrated; and
configuring a basic input/output system option of the server to switch to the reliability mode based on the reliability flag during restarting the server.

In some embodiments of the present application, the step of switching the server configuration mode to the operability mode, in response to the service migration state being service-migrated includes:
setting a mode flag of the server as an operational flag corresponding to the operability mode, and controlling the server to restart, in response to the service migration state being service-migrated; and
configuring the basic input/output system option of the server to switch to the operability mode based on the operational flag during restarting the server.

In some embodiments of the present application, the server configuration mode further includes a balanced mode and an auto mode, an operational efficiency of the balanced mode is between the operational efficiency of the reliability mode and the operational efficiency of the operability mode, and an operating reliability of the balanced mode is between the operating reliability of the reliability mode and the operating reliability of the operability mode; and the auto mode multiplexes one of the operability mode, the reliability mode, and the balanced mode.

In some embodiments of the present application, the method further includes:
displaying a mode selection page, in response to the server starting and operating normally.

In some embodiments of the present application, the method further includes:
receiving a selection operation for the mode selection page, and selecting one of the reliability mode, the operability mode, the balanced mode and the auto mode as a current configuration mode.

In some embodiments of the present application, the preset service fluctuation threshold is 30%.

The embodiments of the present application is implemented by calculating a first utilization rate of a central processing unit, in response to a server starting and operating normally; determining a fault component, in response to the server crashing and restarting; calculating a second utilization rate of the central processing unit; determining a service migration state based on the first utilization rate and the second utilization rate; switching a server configuration mode according to the service migration state; and isolating the fault component in the server configuration mode. It is determined whether the service of the client migrates by the utilization rate of the central processing unit during normal starting and restarting, and different server configuration modes are started according to whether the service migrates, so that the server may automatically switch the configuration model, and the crash rate of the server is reduced.

The embodiments of the description are described in the mode of progression, each of the embodiments emphatically describes the differences from the other embodiments, and the same or similar parts of the embodiments may be referred to each other.

It will be appreciated by a person skilled in the art that the embodiments of the present application may be provided as a method, apparatus, or computer program product. Accordingly, the embodiments of the application may take the form of an entirely hardware embodiment, an entirely software embodiment or an embodiment combining software and hardware aspects. Furthermore, the embodiments of the present application may take the form of a computer program product embodied on one or more non-transitory readable storage medium having computer usable program code embodied therein, including, but not limited to, magnetic disk storage, compact disc read-only memory (CD-ROM), optical storage, and the like.

The embodiments of the present application are described referring to the flow diagram and/or block diagram showing the method, terminal device (system), and computer program product according to the embodiments of the present application. It will be understood that each flow and/or block of the flow diagrams and/or block diagrams, and combinations of flows and/or blocks in the flow diagrams and/or block diagrams, may be implemented by computer program instructions. These computer program instructions may be provided to a processing unit of a general-purpose computer, special purpose computer, embedded processing unit, or other programmable data processing terminal device to produce a machine, so that the instructions, which execute via the processing unit of the computer or other programmable data processing terminal device, create means for implementing the functions specified in the flow diagram flow or flows and/or block diagram block or blocks.

These computer program instructions may also be stored in a non-transitory readable storage medium that may direct a computer or other programmable data processing terminal device to function in a manner, such that the instructions stored in the non-transitory readable storage medium produce an article of manufacture including an instruction apparatus. This instruction apparatus implements the functions specified in one or more processes of the flow diagram and/or one or more blocks of the block diagram.

These computer program instructions may also be loaded onto a computer or other programmable data processing terminal device to cause a series of operational steps to be carried out on the computer or other programmable terminal device to produce a computer implemented process so that the instructions which execute on the computer or other programmable terminal device provide steps for implementing the functions specified in the flow diagram flow or flows and/or block diagram block or blocks.

Although the embodiments of the embodiments of the present application have been described, a person skilled in the art may make additional changes and modifications to these embodiments once they become aware of the basic creative concepts. Therefore, the appended claims are intended to be construed as including the embodiments and all changes and modifications that fall within the scope of the embodiments of the present application.

Finally, it is further noted that relational terms such as first and second, and the like, may be used herein to distinguish one entity or action from another entity or action without necessarily requiring or implying any actual such relationship or order between such entities or actions. Further, the terms “include”, “including”, or any other variation thereof, are intended to cover a non-exclusive inclusion, such that a process, method, article, or terminal device that includes a list of elements does not include only those elements but may include other elements not expressly listed or inherent to such process, method, article, or terminal device. An element proceeded by the phrase “includes a . . . ” does not, without more constraints, preclude the existence of additional identical elements in the process, method, article, or terminal device that includes the element.

A detailed introduction to the method and apparatus for configuring server maintainability, an electronic device and a non-transitory readable storage medium are provided by the present application. Examples are used herein to explain the principles and implementation methods of the present application. The descriptions of the above embodiments are intended to help understand the method and its core ideas of the present application. At the same time, for a person skilled in the art in the art, based on the ideas of the present application, there will be changes in implementation methods and application scopes. Therefore, the content of this specification should not be construed as limiting the present application.

1. A method for configuring server maintainability, wherein a server used in the method comprises a baseboard management controller and a central processing unit, the method comprises:
calculating, by the baseboard management controller, a first utilization rate of the central processing unit, in response to a server starting and operating normally;
determining, by the baseboard management controller, a fault component, in response to the server crashing and restarting;
calculating, by the baseboard management controller, a second utilization rate of the central processing unit;
determining, by the baseboard management controller, a service migration state based on the first utilization rate and the second utilization rate;
switching, by the baseboard management controller, a server configuration mode according to the service migration state; and
isolating, by the baseboard management controller, the fault component in the server configuration mode.

2. The method according to claim 1, wherein the step of calculating, by the baseboard management controller, the first utilization rate of the central processing unit comprises:
reading power consumption data and unit heat data of the central processing unit; and
determining the first utilization rate according to the power consumption data and the unit heat data.

3. The method according to claim 2, wherein the step of determining the first utilization rate according to the power consumption data and the unit heat data comprises:
calculating a first ratio of the power consumption data to the unit heat data; and
determining the first ratio as the first utilization rate.

4. The method according to claim 1, wherein the step of determining, by the baseboard management controller, the fault component, in response to the server crashing and restarting comprises:
reading error information, in response to the server crashing and restarting; and
determining that a component corresponding to the error information is the fault component.

5. The method according to claim 4, wherein before the step of reading the error information, the step of determining the fault component, in response to the server crashing and restarting further comprises:
waiting for a preset duration to enter a basic input/output system of the server.

6. The method according to claim 1, wherein the step of calculating, by the baseboard management controller, the second utilization rate of the central processing unit comprises:
reading power consumption data and unit heat data of the central processing unit; and
determining the second utilization rate according to the power consumption data and the unit heat data.

7. The method according to claim 6, wherein the step of determining the second utilization rate according to the power consumption data and the unit heat data comprises:
calculating a second ratio of the power consumption data to the unit heat data; and
determining the second ratio as the second utilization rate.

8. The method according to claim 1, wherein the step of determining, by the baseboard management controller, the service migration state based on the first utilization rate and the second utilization rate comprises:
calculating a service fluctuation value based on the first utilization rate and the second utilization rate; and
determining the service migration state based on the service fluctuation value.

9. The method according to claim 8, wherein the step of calculating the service fluctuation value based on the first utilization rate and the second utilization rate comprises:
calculating a difference between the first utilization rate and the second utilization rate;
calculating a third ratio of the difference to the first utilization rate; and
determining the third ratio to be the service fluctuation value.

10. The method according to claim 8, wherein the step of determining the service migration state based on the service fluctuation value comprises:
determining whether the service fluctuation value is less than a preset service fluctuation threshold;
determining that the service migration state is service non-migrated, in response to the service fluctuation value being less than the preset service fluctuation threshold; and
determining that the service migration state is service-migrated, in response to the service fluctuation value not being less than the preset service fluctuation threshold.

11. The method according to claim 10, wherein the server configuration mode comprises a reliability mode and an operability mode, operational reliability of the reliability mode is greater than operational reliability of the operability mode, and an operational efficiency of the operability mode is greater than an operational efficiency of the reliability mode; and the step of switching the server configuration mode according to the service migration state comprises:
switching the server configuration mode to the reliability mode, in response to the service migration state being service non-migrated; and
switching the server configuration mode to the operability mode, in response to the service migration state being service-migrated.

12. The method according to claim 11, wherein the step of switching the server configuration mode to the reliability mode, in response to the service migration state being service non-migrated comprises:
setting a mode flag of the server as a reliability flag corresponding to the reliability mode, and controlling the server to restart, in response to the service migration state being service non-migrated; and
configuring a basic input/output system option of the server to switch to the reliability mode based on the reliability flag during restarting the server.

13. The method according to claim 11, wherein the step of switching the server configuration mode to the operability mode, in response to the service migration state being service-migrated comprises:
setting a mode flag of the server as an operational flag corresponding to the operability mode, and controlling the server to restart, in response to the service migration state being service-migrated; and
configuring a basic input/output system option of the server to switch to the operability mode based on the operational flag during restarting the server.

14. The method according to claim 11, wherein the server configuration mode further comprises a balanced mode and an auto mode, an operational efficiency of the balanced mode is between the operational efficiency of the reliability mode and the operational efficiency of the operability mode, and an operating reliability of the balanced mode is between the operating reliability of the reliability mode and the operating reliability of the operability mode; and the auto mode multiplexes one of the operability mode, the reliability mode and the balanced mode.

15. The method according to claim 14, wherein the method further comprises:
displaying, by the server, a mode selection page, in response to the server starting and operating normally.

16. The method according to claim 15, wherein the method further comprises:
receiving, by the baseboard management controller, a selection operation for the mode selection page, and selecting one of the reliability mode, the operability mode, the balanced mode and the auto mode as a current configuration mode.

17. The method according to claim 10, wherein the preset service fluctuation threshold is 30%.

18. An electronic device, comprising a processor, a memory, and a computer program stored on the memory and capable of operating on the processor, the computer program in response to being executed by the processor implementing the steps of the method for configuring the server maintainability according to claim 1.

19. A non-transitory readable storage medium, wherein the non-transitory readable storage medium has stored thereon a computer program, the computer program, in response to being executed by a processor, implementing the steps of the method for configuring the server maintainability according to claim 1.

20. The method according to claim 2, wherein the unit heat data refers to an indicator of heat release of a processor.
